(19) United States
(12) Patent Application Publication
(10) Pub. No.: US 2009/0138857 A1
(43) Pub. Date: May 28, 2009

(54) DEVICE, SYSTEM, AND METHOD OF TESTING COMPUTER PROGRAMS

(76) Inventors: David Botzer, Haifa (IL); Aviad Zlotnick, Mitzpe Netofa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/946,052

(22) Filed: Nov. 28, 2007

(51) Int. Cl. G06F 9/44

(52) U.S. Cl. 717/129

(57) ABSTRACT

Device, system, and method of testing computer programs. For example, an apparatus for testing computer programs includes: a debugger to detect a breakpoint in a computer program, and to issue an event indicating one or more properties of the breakpoint; and an event processing engine to control the operation of the debugger based on event processing analysis that takes into account the event issued by the debugger.

### FIELD

Some embodiments of the invention are related to the field of computer programming, and more particularly to testing of computer programs.

### BACKGROUND

Testing of a computer program is a process of executing the computer program multiple times in order to ensure that it functions as expected or produces correct results. In a testing process it may be difficult to ensure that substantially all, or most of, the statements of the computer program are executed and produce correct results. Particularly, it may be difficult to ensure in a testing process that all the statements of a “bad path” code portion (namely, a code portion that is executed when the computer program or the computer do not function as expected) were executed and produced correct results. For example, it may be difficult, and in some cases substantially impossible, to create the conditions that force execution of some portions of the computer program.

A debugger may be used to force execution paths by setting breakpoints and modifying values of one or more variables when breakpoints are reached. Unfortunately, particularly in large or complex software systems, utilization of breakpoints may be insufficient for forcing the required execution paths.

Similarly, a debugger may be used to produce debug printouts and traces. Unfortunately, producing a printout or a trace at a particular program location each time the program location is visited may impact performance, and may further result in an excessive amount of data which may not be analyzed efficiently or rapidly.

### SUMMARY

Some embodiments of the invention include, for example, devices, systems, and methods of testing computer programs.

In some embodiments, for example, an apparatus for testing computer programs includes: a debugger to detect a breakpoint in a computer program, and to issue an event indicating one or more properties of the breakpoint; and an event processing engine to control the operation of the debugger based on event processing analysis that takes into account the event issued by the debugger.

In some embodiments, for example, a method for testing computer programs includes: detecting a breakpoint during debugging of a computer program; issuing an event indicating one or more properties of the breakpoint; and controlling the operation of a debugger based on event processing analysis that takes into account the event issued by the debugger.

Some embodiments include, for example, a computer program product including a computer-useable medium including a computer-readable program, wherein the computer-readable program when executed on a computer causes the computer to perform method(s) in accordance with some embodiments of the invention.

Some embodiments of the invention may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system for testing computer programs in accordance with some demonstrative embodiments of the invention.

FIG. 2 is a schematic flow-chart of a method of testing computer programs in accordance with some demonstrative embodiments of the invention.

### DETAILED DESCRIPTION

In the following detailed description, numerous specific details are set forth in order to provide a thorough understanding of some embodiments of the invention. However, it will be understood by persons of ordinary skill in the art that embodiments of the invention may be practiced without these specific details. In other instances, well-known methods, procedures, components, units and/or circuits have not been described in detail so as not to obscure the discussion.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein includes, for example, “multiple” or “two or more”. For example, “a plurality of items” includes two or more items.

Although portions of the discussion herein relate, for demonstrative purposes, to wired links and/or wired communications, embodiments of the invention are not limited in this regard, and may include one or more wired and/or wireless links, may utilize one or more components of wireless communication, and may utilize one or more methods or protocols of wireless communication. Some embodiments of the invention may utilize wired communication and/or wireless communication.

The terms “program” “computer program” or “code” as used herein include, for example, a source code, a computer program, a code or program written in a high-level programming language, a code or program written in a very high-level programming language, a code or program written in a low-level programming language, an assembly code or program, a machine language code or program, a single-thread program, a multiple-thread program, a portion of a code or program, a segment of a code or program, one or more instructions or sets of instructions, one or more subroutines, one or more procedures, one or more functions, one or more libraries, a logic, an object-oriented code or program, a portable or non-portable code or program, a code or program that requires compilation by a compiler, an originally-written code or program, a non-optimized code or program, an optimized code or program, a non-modified program, a modified program, a debugged program, a non-debugged program, a pre-compilation program version, a post-compilation program version, a pre-optimization program version, a post-optimization program version, a pre-linking program version, a post-linking program version, a program that was modified manually by a programmer, a program that was modified automatically by a compiler and/or linker and/or debugger and/or optimizer, a program that was subject to one or more iterations of optimization, a program that was subject to one or more methods of optimization, or the like.

The term “statement” as used herein includes, for example, a statement of a computer program, an instruction, a code line, a code portion, a code segment, an expression, a clause, a construct, an operand, an opcode, a string, a set of characters, a portion of a statement, a properly constructed statement, a statement that includes a syntax error or a typing error, a set of consecutive or non-consecutive statements, or the like.

Although portions of the discussion herein relate, for demonstrative purposes, to monitoring and/or profiling and/or matching of conditional statements, embodiments of the invention may be used for monitoring and/or profiling and/or matching of other types of statements, expressions, code portions, constructs, functions, or the like.

At an overview, some embodiments of the invention utilize Event Processing (EP) for testing and debugging computer programs. One or more debuggers are coupled to an EP engine. When a debugger reaches a breakpoint, the debugger issues an event. The EP engine responds to events by controlling the debugger, configuring the debugger, or commanding the debugger to perform one or more operations. For example, the EP engine may analyze the event and determine to continue the execution; to wait for another event to occur; to wait for multiple other events to occur; to wait for a condition to hold true; to wait for a condition to hold false; to wait a time interval; to modify or to set values of one or more variables; to print, “dump”, or otherwise generate output of one or more variables, strings, memory areas, screens, or data; or the like.

In some embodiments, the EP engine controls, commands or configures the debugger (or multiple debuggers), for example, to modify execution flow. This may be performed, for example, while one or more computer programs are being executed, tested or debugged. For example, the EP engine may command the debugger to perform particular actions, based on the progress or history of the current program being debugged, based on the progress or history of other programs (e.g., being concurrently debugged, or previously debugged), based on input or events received from one or more other debuggers, based on external information (e.g., date information, time information, system resources availability, or the like), or based on other event analysis.

In some embodiments, optionally, the debugger is configured to activate a breakpoint only if a condition holds true, for example, only after visiting a particular statement a pre-defined number of times, or only during a pre-defined number of visits (e.g., first visits) at a particular statement. Optionally, the history of visited breakpoints may be utilized to selectively activate other breakpoints.

In some embodiments, the EP engine includes a Complex EP (CEP) engine able to utilize one or more CEP techniques, for example, detection of complex patterns of multiple events, event correlation and abstraction, event hierarchies, and relationships between events (e.g., causality, membership, timing, or the like). For example, the EP engine may trace and detect meaningful patterns of events, and may determine or infer that a breakpoint that is reached is to be activated or deactivated.

The coupling of one or more debuggers with the EP engine allows flexible and efficient testing and debugging of computer programs. For example, it allows coordination of the debugging of multiple software programs or multiple sub-systems, and allows creation of high coverage regression tests for large systems. Some embodiments thus enhance the level of control over a testing or debugging process of a software system.

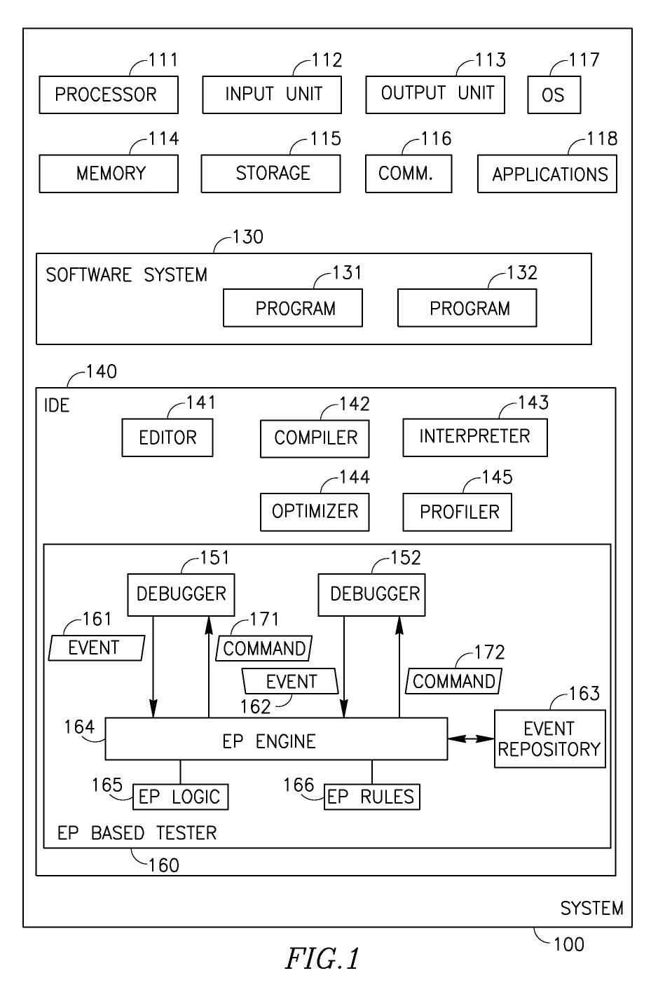

FIG. 1 schematically illustrates a block diagram of a system 100 for testing computer programs in accordance with some demonstrative embodiments of the invention. System 100 may be or may include, for example, a computing device, a computer, a Personal Computer (PC), a server computer, a client/server system, a mobile computer, a portable computer, a laptop computer, a notebook computer, a tablet computer, a network of multiple inter-connected devices, or the like.

System 100 includes, for example, a processor 111, an input unit 112, an output unit 113, a memory unit 114, a storage unit 115, and a communication unit 116. System 100 may optionally include other suitable hardware components and/or software components.

Processor 111 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 111 executes instructions, for example, of an Operating System (OS) 117 of system 100 or of one or more software applications 118.

Input unit 112 includes, for example, a keyboard, a keypad, a mouse, a touch-pad, a track-ball, a stylus, a microphone, or other suitable pointing device or input device. Output unit 113 includes, for example, a monitor, a screen, a Cathode Ray Tube (CRT) display unit, a Liquid Crystal Display (LCD) display unit, a plasma display unit, one or more audio speakers or earphones, or other suitable output devices.

Memory unit 114 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 115 includes, for example, a hard disk drive, a floppy disk drive, a Compact Disk (CD) drive, a CD-ROM drive, a Digital Versatile Disk (DVD) drive, or other suitable removable or non-removable storage units. Memory unit 114 and/or storage unit 115, for example, store data processed by system 100.

Communication unit 116 includes, for example, a wired or wireless Network Interface Card (NIC), a wired or wireless modem, a wired or wireless receiver and/or transmitter, a wired or wireless transmitter-receiver and/or transceiver, a Radio Frequency (RF) communication unit or transceiver, or other units able to transmit and/or receive signals, blocks, frames, transmission streams, packets, messages and/or data. Optionally, communication unit 116 includes, or is associated with, one or more antennas, for example, a dipole antenna, a monopole antenna, an omni-directional antenna, an end fed antenna, a circularly polarized antenna, a micro-strip antenna, a diversity antenna, or the like.

In some embodiments, the components of system 100 may be enclosed in a common housing or packaging, and may be interconnected or operably associated using one or more wired or wireless links. In other embodiments, components of system 100 may be distributed among multiple or separate devices or locations, may be implemented using a client/server configuration, may communicate using remote access methods, or the like.

System 100 includes one or more programs, for example, programs 131-132. Programs 131 and/or 132 include a source code, for example, written in a high-level programming language. In some embodiments, programs 131-132 may be related, or may be part of a software system 130 under development.

Programs 131 and/or 132 are composed and edited (e.g., separately, independently, in serial, in parallel, or the like) using a software development tool, for example, an Integrated Development Environment (IDE) 140. The IDE 140 includes one or more tools, for example, a source code editor 141, a compiler 142 and/or an interpreter 143, an optimizer 144, and a profiler 145. The IDE 140 further includes one or more debuggers, for example, debuggers 151 and 152. The IDE 140 may include other and/or additional components, for example, automation tools, a version control system, tools to facilitate the construction of a Graphic User Interface (GUI), visual programming tools, or the like.

Optionally, the IDE 140 includes, or is associated with, an Event Processing (EP) based tester 160, which includes one or more of the components described herein, and/or performs one or more of the functions described herein.

In some embodiments, debugger 151 is activated (e.g., manually or automatically) to debug program 131; and debugger 152 is activated (e.g., manually or automatically) to debug program 131, for example, in parallel, in serial, at an overlapping time period, or the like. In other embodiments, debugger 151 is activated to debug program 131, and debugger 152 is not activated, or vice versa. In yet other embodiments, other number of debuggers may be used, may be activated, may be deactivated, or may debug other number of programs. In some embodiments, multiple instances of debugger 151 may be executed in parallel, each instance debugging a different program. In other embodiments, multiple instances of debugger 151, as well as multiple instances of debugger 152, may be executed in parallel, each instance debugging a different program. In some embodiments, multiple debuggers, or multiple instances of debugger(s), may be executed in parallel or concurrently on multiple processors or multiple processor cores.

For example, program 131 may include the following demonstrative code portion, denoted Code 1:

Code 1

| | | |
|---|---|---|
| 01 | Switch (x) { | // if breakpoint Finish was visited, then |

break here, set x to Error, and continue
execution

| 02 | case Process: | |
|---|---|---|
| 03 | function1( ); | |
| 04 | break; | |
| 05 | case Finish: | |
| 06 | function2( ); | // breakpoint Finish |

| | |
|---|---|
| 07 | break; |
| 08 | case Error: |
| 09 | function 3( ); |
| 10 | break; |
| 11 | } |

Code 1 demonstrates history-based activation of a breakpoint, which may be utilized in accordance with some embodiments of the invention.

In some embodiments, for example, debugger 151 debugs program 131, reaches a breakpoint (denoted herein breakpoint “A”), and issues an event 161. The event 161 indicates information related to the reached breakpoint or one or more properties or characteristics of the breakpoint, for example, an indication that the breakpoint is reached, an indication of the breakpoint location, a date/time stamp of reaching the breakpoint, or the like. The event 161 is issued to and/or transferred to an EP engine 164. Optionally, event 161 is transferred to, and/or stored in, an event repository 163 which logs incoming events, for example, received from debugger 151 and/or from debugger 152. In some embodiments, issued event(s) are directly transferred from debugger 151 to the EP engine 164; and the EP engine 164 may optionally store the issued event(s) for subsequent reference or analysis.

The EP engine 164 may include, or may be associated with, EP logic 165 (e.g., CEP logic), and/or one or more EP rules 166. Based on the EP logic 165 and/or the EP rules 166, and taking into account the event 161 and optionally other events (e.g., events issued previously and/or in parallel by debugger 151 and/or by debugger 152, or events stored in the event repository 163), the EP engine 164 dynamically controls and/or modifies and/or configures the operation of debugger 151 (and optionally, of debugger 152).

For example, the EP engine 164 dynamically issues a command 171 (or multiple commands) to debugger 151, instructing the debugger 151 to perform an operation or to refrain from performing an operation. Command 171 may include one or more commands to wait, to halt, to pause execution, to continue execution, to modify the execution path, to continue execution from another location, to alert, to break, to report, to modify values of one or more variables, to conditionally alert, to conditionally report, to conditionally break, to conditionally alert, to printout or “dump” memory areas and/or variable values, to immediately break (e.g., independently of other statements or programs currently being executed), to create or set a new breakpoint at another program location, to modify a current breakpoint, or the like.

Debugger 151 receives and executes the command 171. Optionally, command 171 is further stored in the event repository 163, for example, in association with a record indicating the corresponding event 161. The EP engine 164 subsequently takes into account commands that were previously-issued to debugger 151 (and/or to debugger 152) when determining course of action in response to an incoming event.

In some embodiments, EP logic 165 and/or EP rules 166 include, for example, logic or rule instructing the debugger 151 to alert, to report and/or to break (or to issue an event) if one or more of breakpoints “B”, “C” and “D” is reached within T milliseconds of reaching breakpoint “A”. The value of T may be pre-set or pre-defined, or may be dynamically calculated or determined by the EP engine 164 (e.g., based on EP analysis). In some embodiments, EP logic 165 and/or EP rules 166 include, for example, logic or rule instructing the debugger 151 to modify a content of a memory area, to modify execution path, to activate a breakpoint, or to deactivate a breakpoint.

In some embodiments, EP logic 165 and/or EP rules 166 include, for example, logic or rule instructing the debugger 151 to alert, to report and/or to break (or to issue an event) if none of breakpoints “B”, “C” and “D” are reached within T milliseconds of reaching breakpoint “A”. The value of T may be pre-set or pre-defined, or may be dynamically calculated or determined by the EP engine 164 (e.g., based on EP analysis).

In some embodiments, EP logic 165 and/or EP rules 166 include, for example, logic or rule instructing the debugger 151 to alert, to report and/or to break (or to issue an event) if a particular code portion (e.g., one or more particular statements or functions) was not reached (e.g., not even once) in the last N runs or iterations. The value of N may be pre-set or pre-defined, or may be dynamically calculated or determined by the EP engine 164 (e.g., based on EP analysis).

In some embodiments, EP logic 165 and/or EP rules 166 include, for example, logic or rule instructing the debugger 151 to alert, to report and/or to break (or to issue an event) if a particular code portion (e.g., one or more particular statements or functions) was not reached (e.g., not even once) in the last T milliseconds. The value of T may be pre-set or pre-defined, or may be dynamically calculated or determined by the EP engine 164 (e.g., based on EP analysis).

In some embodiments, EP logic 165 and/or EP rules 166 include, for example, logic or rule instructing the debugger 151 to alert, to report and/or to break (or to issue an event) if the number of breakpoints that were reached from a first group of breakpoints, is greater by at least K from the number of breakpoints that were reached from a second group of breakpoints. The value of K may be pre-set or pre-defined, or may be dynamically calculated or determined by the EP engine 164 (e.g., based on EP analysis). This may allow the EP engine 164 to determine that a nesting is excessively deep; for example, breakpoints of the first group are associated with program locations that start a new nesting level, whereas breakpoints of the second group are associated with program locations that return from nested code.

In some embodiments, EP logic 165 and/or EP rules 166 include, for example, logic or rule instructing the debugger 151 to alert, to report and/or to break (or to issue an event) if a module or function or code portion did not perform an “exit” within T milliseconds from the execution of a particular statement. The value of T may be pre-set or pre-defined, or may be dynamically calculated or determined by the EP engine 164 (e.g., based on EP analysis).

In some embodiments, EP logic 165 and/or EP rules 166 include, for example, logic or rule instructing the debugger 151 to alert, to report and/or to break (or to issue an event) if a particular statement was executed at least N times (e.g., cumulatively, and/or within a time period of T milliseconds). The values of T and/or N may be pre-set or pre-defined, or may be dynamically calculated or determined by the EP engine 164 (e.g., based on EP analysis). For example, by setting the value of N to be higher than an intended or expected or operationally normal value, excessive execution of the statement may be detected.

In some embodiments, EP logic 165 and/or EP rules 166 include, for example, logic or rule instructing the debugger 151 to alert, to report and/or to break (or to issue an event) if a particular module or function was called by at least K other modules or functions (e.g., cumulatively, and/or within a time period of T seconds). The values of T and/or K may be pre-set or pre-defined, or may be dynamically calculated or determined by the EP engine 164 (e.g., based on EP analysis). This may allow, for example, detection of critical modules or functions, or detection of frequently-called functions or modules.

In some embodiments, EP logic 165 and/or EP rules 166 include, for example, logic or rule instructing the debugger 151 to alert, to report and/or to break (or to issue an event) if a particular module or function did not perform a regular successful “exit” at least N times in the last T seconds. The values of T and/or N may be pre-set or pre-defined, or may be dynamically calculated or determined by the EP engine 164 (e.g., based on EP analysis).

In some embodiments, EP logic 165 and/or EP rules 166 include, for example, logic or rule instructing the debugger 151 to alert, to report and/or to break (or to issue an event) if a particular statement is reached on a Saturday (or on a Sunday, or on a weekend, or, in contrast, on a weekday), or during a time period in which another application is executed (or is not executed).

In some embodiments, EP logic 165 and/or EP rules 166 include, for example, logic or rule instructing the debugger 151 to alert, to report and/or to break (or to issue an event) if a combination of conditions holds true, for example: if a particular statement was reached at least N times, and a number of breakpoints that were reached from a first group of breakpoints is greater by at least K from the number of breakpoints that were reached from a second group of breakpoints. Other suitable conditions may be used.

In some embodiments, EP engine 164 and/or EP based tester 160 are part of IDE 140, and are not a general “rule engine” (e.g., a general if-then rule processor) or a “programming language”, for example, since the EP engine 164 and/or EP based tester 160 utilize and analyze one or more events (e.g., in addition to processing if-then conditions).

In some embodiments, EP engine 164 may analyze and take into account events incoming from multiple debuggers (e.g., debuggers 151-152), and/or events generated by debugging of multiple programs (e.g., programs 131-132). For example, debugger 151 may debug program 131 and issue event 161, whereas debugger 151 may debug program 132 and issue an event 162. The EP engine 164 analyzes, or takes into account, events 161 and 162; issues command 171 to debugger 151; and issues a command 172 to debugger 152. Other suitable configurations may be used to couple one or more debuggers to the EP engine 164, or to otherwise combine the functionalities of one or more debuggers with the EP engine 164.

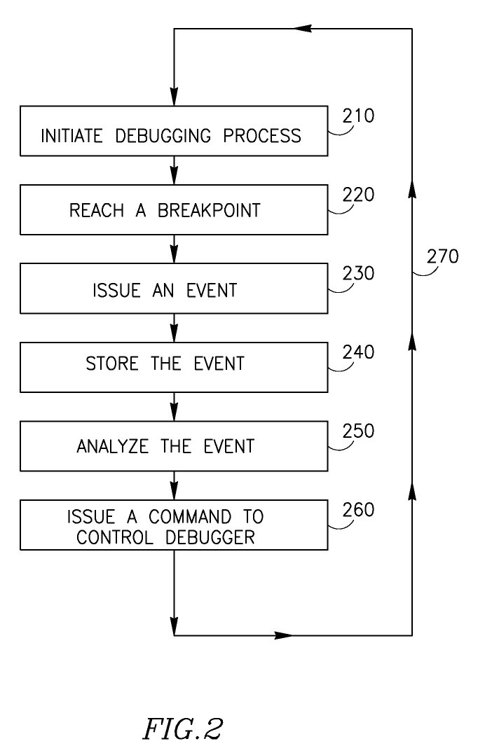

FIG. 2 is a schematic flow-chart of a method of testing computer programs in accordance with some demonstrative embodiments of the invention. Operations of the method may be used, for example, by system 100 of FIG. 1, by IDE 140 of FIG. 1, by the EP based tester 160 of FIG. 1, and/or by other suitable units, devices and/or systems.

In some embodiments, the method may include, for example, initiating a debugging process of a computer program (block 210).

In some embodiments, the method may include, for example, reaching a breakpoint (block 220).

In some embodiments, the method may include, for example, issuing an event (block 230).

In some embodiments, the method may include, for example, storing the event in an event repository (block 240).

In some embodiments, the method may include, for example, analyzing the event (block 250). This may include, for example, analyzing the event using pre-defined EP rules and/or EP logic, which takes into account, for example, the event, other or previous events issued with regard to the computer program, and/or other events or previous events issued with regard to another computer program.

In some embodiments, the method may include, for example, issuing a command to control the debugger (block 260).

In some embodiments, for example, the operations of block 220 and onward may be repeated (arrow 270).

Other suitable operations or sets of operations may be used; some operations may be repeated for multiple iterations; operations may be performed in other suitable order.

Functions, operations, components and/or features described herein with reference to one or more embodiments, may be combined with, or may be utilized in combination with, one or more other functions, operations, components and/or features described herein with reference to one or more other embodiments, or vice versa.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes.

What is claimed is:

1. An apparatus for testing computer programs, the apparatus comprising:
a debugger to detect a breakpoint in a computer program, and to issue an event indicating one or more properties of the breakpoint; and
an event processing engine to control the operation of the debugger based on event processing analysis that takes into account the event issued by the debugger.

2. The apparatus of claim 1, wherein the event processing engine is to generate a command to the debugger based on said analysis.

3. The apparatus of claim 2, wherein the debugger is to issue a plurality of events indicating one or more properties of a respective plurality of breakpoints, and wherein the event processing engine is to use Complex Event Processing logic to analyze said plurality of events.

4. The apparatus of claim 2, wherein the event processing engine is to operate according to a set of event processing rules indicating one or more conditions for generating event-based commands to control the debugger.

5. The apparatus of claim 2, wherein the event processing engine is to control the operation of the debugger by a command selected from the group consisting of:
a command instructing the debugger to pause program execution;
a command instructing the debugger to continue program execution;
a command instructing the debugger to modify program execution path;
a command instructing the debugger to modify a content of a memory area;
a command instructing the debugger to activate a breakpoint;
a command instructing the debugger to deactivate a breakpoint;
a command instructing the debugger to wait a pre-defined time period;
a command instructing the debugger to wait until receiving a command to continue;
a command instructing the debugger to generate an alert if a condition holds true;
a command instructing the debugger to generate a report if a condition holds true; and
a command instructing the debugger to break program execution if a condition holds true.

6. The apparatus of claim 2, wherein the event processing engine is to control the operation of the debugger by a command selected from the group consisting of:
a command instructing the debugger to perform an operation if another event was issued by the debugger;
a command instructing the debugger to perform an operation if another event was not issued by the debugger;
a command instructing the debugger to perform an operation if another event was issued by another debugger; and
a command instructing the debugger to perform an operation if another event was not issued by another debugger.

7. The apparatus of claim 2, wherein the event processing engine is to control the operation of the debugger by a command selected from the group consisting of:
a command instructing the debugger to perform an operation if another breakpoint is reached within a defined time period;
a command instructing the debugger to perform an operation if another breakpoint is not reached within a defined time period;
a command instructing the debugger to perform an operation if a particular statement of the computer program was not reached within an elapsed time period;
a command instructing the debugger to perform an operation if a particular statement of the computer program was executed at least a particular number of times within an elapsed time period;
a command instructing the debugger to perform an operation if a particular module of the computer program did not successfully exit within an elapsed time period;
a command instructing the debugger to perform an operation if a particular module of the computer program was called by at least a particular number of other modules within an elapsed time period;
a command instructing the debugger to perform an operation if a particular statement of the computer program was not reached within an elapsed time period; and
a command instructing the debugger to perform an operation based on the difference between: the number of breakpoints that were reached from a first group of breakpoints, and the number of breakpoints that were reached from a second group of breakpoints.

8. The apparatus of claim 1, comprising:
an event repository to store a plurality of events issued by the debugger and by at least one other debugger,
wherein the event processing engine is to control the operation of the debugger by a command that is based on an analysis of at least one event issued by the debugger and at least one event issued by the other debugger.

9. The apparatus of claim 1, comprising:
an event repository to store one or more events issued by a first instance of the debugger and one or more events issued by a second, concurrent, instance of the debugger,
wherein the event processing engine is to control the operation of the debugger by a command that is based on an analysis of at least one event issued by the first instance of the debugger and at least one event issued by the second instance of the debugger.

10. A method for testing computer programs, the method comprising:
detecting a breakpoint during debugging of a computer program;
issuing an event indicating one or more properties of the breakpoint; and
controlling the operation of a debugger based on event processing analysis that takes into account the event issued by the debugger.

11. The method of claim 10, wherein controlling the operation of the debugger comprises:
generating a command to the debugger based on said analysis.

12. The method of claim 11, comprising:
issuing a plurality of events indicating one or more properties of a respective plurality of breakpoints; and
using Complex Event Processing logic to analyze said plurality of events.

13. The method of claim 11, wherein controlling the operation of the debugger comprises:
applying a set of event processing rules indicating one or more conditions for generating event-based commands to control the debugger.

14. The method of claim 11, wherein controlling the operation of the debugger comprises:
generating a command selected from the group consisting of:
a command instructing the debugger to pause program execution;
a command instructing the debugger to continue program execution;
a command instructing the debugger to modify program execution path;
a command instructing the debugger to modify a content of a memory area;
a command instructing the debugger to activate a breakpoint;
a command instructing the debugger to deactivate a breakpoint;
a command instructing the debugger to wait a pre-defined time period;
a command instructing the debugger to wait until receiving a command to continue;
a command instructing the debugger to generate an alert if a condition holds true;
a command instructing the debugger to generate a report if a condition holds true; and
a command instructing the debugger to break program execution if a condition holds true.

15. The method of claim 11, wherein controlling the operation of the debugger comprises:
generating a command selected from the group consisting of:
a command instructing the debugger to perform an operation if another event was issued by the debugger;
a command instructing the debugger to perform an operation if another event was not issued by the debugger;
a command instructing the debugger to perform an operation if another event was issued by another debugger; and
a command instructing the debugger to perform an operation if another event was not issued by another debugger.

16. The method of claim 11, wherein controlling the operation of the debugger comprises:
generating a command selected from the group consisting of:
a command instructing the debugger to perform an operation if another breakpoint is reached within a defined time period;
a command instructing the debugger to perform an operation if another breakpoint is not reached within a defined time period;
a command instructing the debugger to perform an operation if a particular statement of the computer program was not reached within an elapsed time period;
a command instructing the debugger to perform an operation if a particular statement of the computer program was executed at least a particular number of times within an elapsed time period;
a command instructing the debugger to perform an operation if a particular module of the computer program did not successfully exit within an elapsed time period;
a command instructing the debugger to perform an operation if a particular module of the computer program was called by at least a particular number of other modules within an elapsed time period;
a command instructing the debugger to perform an operation if a particular statement of the computer program was not reached within an elapsed time period; and
a command instructing the debugger to perform an operation based on the difference between: the number of breakpoints that were reached from a first group of breakpoints, and the number of breakpoints that were reached from a second group of breakpoints.

17. The method of claim 10, comprising:
storing a plurality of events issued by the debugger and by at least one other debugger; and
controlling the operation of the debugger by a command that is based on an analysis of at least one event issued by the debugger and at least one event issued by the other debugger.

18. The method of claim 10, comprising:
storing one or more events issued by a first instance of the debugger and one or more events issued by a second, concurrent, instance of the debugger; and
controlling the operation of the debugger by a command that is based on an analysis of at least one event issued by the first instance of the debugger and at least one event issued by the second instance of the debugger.

19. A computer program product comprising a computer useable medium including a computer readable program, wherein the computer readable program when executed on a computer causes the computer to perform a method comprising:
detecting a breakpoint during debugging of a computer program;
issuing an event indicating one or more properties of the breakpoint; and
controlling the operation of a debugger based on event processing analysis that takes into account the event issued by the debugger.

20. The computer program product of claim 19, wherein controlling the operation of the debugger comprises:
applying a set of event processing rules indicating one or more conditions for generating event-based commands to control the debugger.
